(19) United States
(12) Patent Application Publication
(10) Pub. No.: US 2007/0048705 A1
(43) Pub. Date: Mar. 1, 2007

(54) Computerized accountability system for tracking student behavior

(76) Inventor: Dean M. Belter, Lake Worth, FL (US)

Correspondence Address: THE INVENTORS NETWORK, INC., 332 ACADEMY STREET, CARNEGIE, PA, 15106, US

(21) Appl. No.: 11/216,350

(22) Filed: Sep. 1, 2005

(51) Int. Cl. G09B 19/00

(52) U.S. Cl. 434/236

(57) ABSTRACT

A computerized accountability system for tracking and recording the behavioral progress and academic developments of students in any academic setting, and adapted for use with Microsoft XL, includes a number of screen layouts, charts and graphs (note that bar graphs are part of the program which only calculates automatically once data has been entered) for recording and tracking on a daily, weekly or quarterly basis through a universal point system numerous aspects of the student behavior such as attendance, following or not following rules, staying on task, using appropriate language, following directions, and security referrals so that the progress of any student can be viewed any time by the teacher, counselor or administrator in order to determine if that student can exit the program or what behaviors need improved or modified so that the student can pass through the required levels to exit the program.

### FIELD OF THE INVENTION

The present invention pertains to systems for the discrete tracking and recording of events and actions, and more particularly pertains to a computerized accountability tracking system for recording, tracking and providing real time information to end users of the status and progress of various student behaviors and academic developments so that they can be evaluated, modified and improved.

### BACKGROUND OF THE INVENTION

Scholastic testing in public schools has been mandated by a number of states, such as the FCAT test implemented by Florida several years ago, to determine the level of skills, aptitudes and knowledge acquired by students at the completion of various grade level, and to determine whether the students should be passed on to the next grade level or held back. In addition, there are numerous proposals for a nationwide test for accomplishing the same purpose as the various state tests. There are many issues involving mandatory state and federal scholastic testing schemes, among the more difficult and controversial issue being that of directly linking the pay of public school teachers to the various test outcomes. This particular problem is compounded by the fact that some students must be sent to special behavioral schools because they are unable to properly function in a normal school setting. Upon successful completion of the behavioral modification program for that respective special behavioral school, the student is returned to the normal school setting with his or her problem behaviors hopefully curbed or rectified. Many of these behavioral modification programs necessitate the daily and hourly tracking of behavior wherein points are accumulated for both positive and negative behavior in order to determine whether the student must remain in the program or can exit the program. However, a severe disadvantage of such programs is that they often consume an inordinate amount of the instructor's time for record keeping and tracking the progress of each student. Moreover, in states where the pay of teachers has been linked to the outcome of test scores, teachers (especially those in behavioral-type schools where the difficulties and stresses are magnified) have the exacting task of simultaneously teaching the curriculum, tracking the progress of their students, and changing—or attempting to change—the negative behaviors of the students in so far as tracking a single homeroom class, if properly done, can itself take between one and one and one half hours of the teacher's time a week. Thus, a behavioral and academic tracking system that minimizes the teacher's time in tracking the various types of behaviors and maximizes the types and categories of behaviors that can be tracked is a sine qua non for alleviating the countless demands placed on the teacher so that actual teaching can remain the foremost activity in the classroom.

The prior art discloses a number of tracking systems and devices for use in educational and non-education settings.

For example, the Darnell patent (U.S. Pat. No. 3,782,009) discloses a behavior modification point board that includes a rectangular-shaped board having slots arranged in rows and columns for receiving markers that denote when a particular student has accomplished a goal or met a particular behavior standard.

The Kossor patent (U.S. Pat. No. 4,741,701) discloses an apparatus for providing visual feedback concerning behavior and includes a flat panel having particular objectives listed from top to bottom on the panel and a shaft having an indicator slidably mounted thereon that can be slidably aligned with the behavior objective to show that that objective has been attained.

The Olsen patent (U.S. Pat. No. 5,399,092) discloses an apparatus for analyzing and diagnosing psychological maladies and includes a board having a surface divided into various psychological diagnostic regions such as mania and depression, and an indicator that can be moved to the appropriate region by the user.

The Feldman patent (U.S. Pat. No. 5,577,915) discloses a motivational task tracking device that includes that includes a board having various ranks and files, and along which color item cards, designating children's activities, can be moved and positioned indicating the completion of the chore or activity denoted by the particular item card.

The Fruge patent (U.S. Pat. No. 5,954,512) discloses a behavior tracking board having a plurality of rows and columns each designating a certain kind of behavior, and markers that can be placed within the squares formed by the intersecting rows and columns indicating the attainment of desirable or undesirable behavior.

Nonetheless, despite the ingenuity of the above systems and devices, there remains a need for a behavior tracking system for students that can track and monitor students' behavior on an ongoing basis and that provides immediately accessible information to the end user on the status and progress of the students' behavior.

### SUMMARY OF THE INVENTION

The present invention comprehends a computerized accountability system for tracking various student behaviors and academic developments in the form of a customized computer software program that is designed to track the progress of each student in the classroom. The accountability tracking system is preferably adapted for use with a Microsoft XL spreadsheet, and can be modified to each teacher, educational or behavioral program or schools specific requirements. The various screen layouts or formats, in the form of customized charts, track and record the daily and weekly behavioral and academic progress of each student, with the screen charts being further organized into quarterly and yearly cumulative charts. The accountability tracking system includes a universal point level system that allows teachers, administrators, school psychologists, etc., to view the students' charts on an ongoing basis for evaluating the status of the students behavioral progress and academic developments for determining what particular areas need improvement as well as the areas where improvement has been demonstrated.

The computerized accountability tracking system includes charts that contain color-coded level boxes each of which denotes the attainment of a specific level of positive behavior, and the appropriate box—or boxes—is checked by the teacher when that goal is attained. The accountability tracking system automatically calculates the results thereby providing the teacher with the student's overall total points and cumulative behavioral totals for any given day or week. All aspects of the students behavior and academic areas are addressed and accounted such as attendance, rules broken, rules followed, ability to stay on task, demonstration of appropriate language and classroom conduct, number of times sent to security, community service hours, etc.; and the various screen layouts or charts also include teacher comment boxes. Thus, the computerized accountability tracking system provides the end user, such as the teacher or administrator, with a detailed and concise profile of status of every student at the institution thereby allowing the teacher or administrator to view each student's progress—or lack thereof—in the specified areas at any given time.

It is an objective of the present invention to provide a computerized accountability system capable of tracking various student behaviors on a daily, weekly, monthly and yearly basis.

It is another objective of the present invention to provide a computerized accountability system for tracking student behaviors that can be used by teachers, administrators, guidance counselors, school psychologists, etc.

It is yet another objective of the present invention to provide a computerized accountability system for tracking student behaviors that can provide information on a particular student's behavioral progress at any given time.

It is still yet another objective of the present invention to provide a computerized accountability system for tracking student behavior that highlights the specific areas of student behavior and conduct that require improvement.

Still yet another objective of the present invention is to provide a computerized accountability system for tracking student behavior that reduces or eliminates the extra workload on teachers as well as the burdensome paperwork and erroneous planning that often result from an inadequate tracking of student progress.

A further objective of the present invention is to provide a computerized accountability system for tracking student behavior that provides germane background information for any given student in order to forewarn the teacher of that student's problem areas and to protect the teacher.

A still further objective of the present invention is to provide a computerized accountability system for tracking student behavior that reduces the data entry and tabulation time from one to one and a half hours a day to approximately ten minutes daily.

Yet another objective of the present invention is to provide a computerized accountability system for tracking student behavior that augments the time management capabilities of the teacher and allows the teacher to determine precisely what problems are preventing the student from making the particular grade or grades.

Yet still another objective of the present invention is to provide a computerized accountability system for tracking student behaviors that facilitates the conveyance of student information from one school to another school when the student transfers without loss of information during the student transfer.

Yet a still further objective of the present invention is to provide a computerized accountability system for tracking student behaviors in which points are accumulated on a daily and weekly basis for both positive and negative behavior for determining whether a student can exit the behavioral program or must remain in the program.

These and other objects, features and advantages will become apparent to one skilled in the art upon a perusal of the following detailed description when read in conjunction will the following drawing figures.

### BRIEF DESCRIPTION OF THE DRAWINGS

FIG. 1 is a front elevational view of a representative primary screen layout or chart illustrating the various boxes, categories, levels that can be checked off and tabulated for charting the behavior and academic progress and development of each student;

FIG. 2 is a front elevational view of a representative screen layout or chart illustrating the various boxes, categories, and levels that comprise the quarterly evaluation of each student;

FIG. 3 is a sectioned elevational view of the screen layout shown in FIG. 2 illustrating a specific area of the screen layout that pertains to the accumulation of points over a period of days for each of the several levels;

FIG. 4 is a schematic view of a flowchart illustrating the various categories of behaviors and actions that are tabulated to determine whether the student has attained the requisite points to exit the program or must remain in the program; and

FIG. 5 is a schematic view of a flowchart illustrating the manner in which the student must accumulate points and/or good days to move through the system from the orientation level to level three.

### DETAILED DESCRIPTION OF THE PREFERRED EMBODIMENT

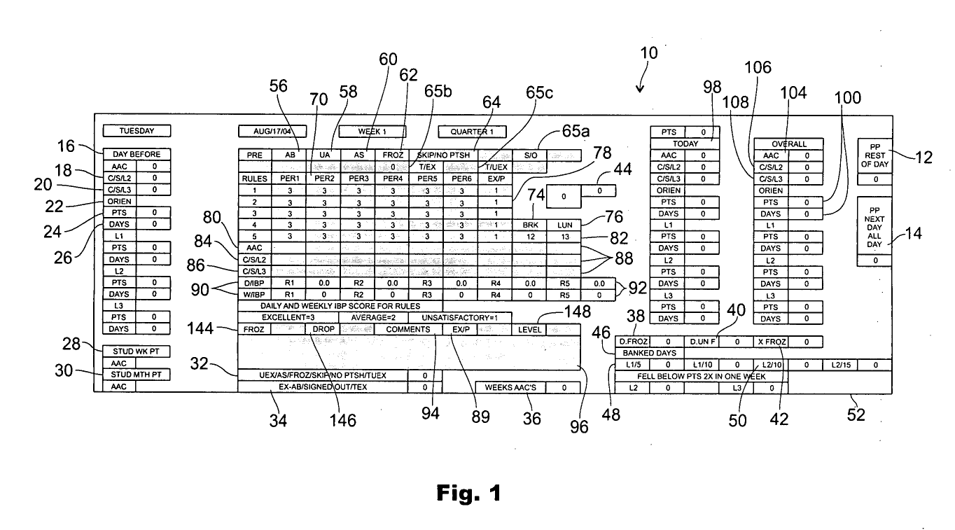

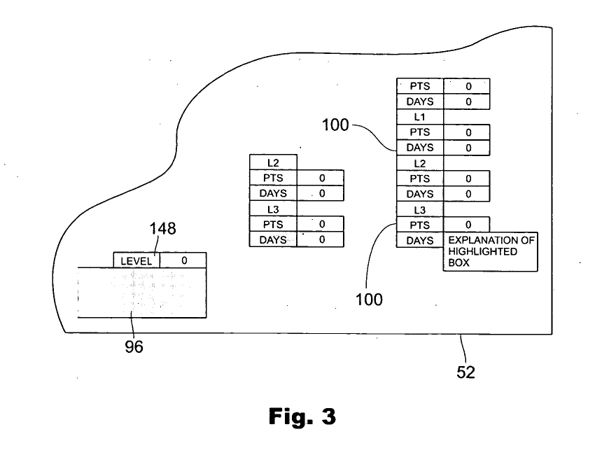

Illustrated in FIGS. 1-5 is a computerized student accountability tracking system 10 and method for recording, documenting and tracking the behavior and academic development of students in an efficient, timesaving manner. The accountability tracking system 10 comprises a behavior modification program through which the student passes by the accumulation of points, and the goal of the tracking system 10 is to identify, modify and improve various aspects of each students' behavior that require changing for successfully passing through the program. The computerized accountability tracking system 10 of the present invention provides for maximum documentation of students behaviors in a minimum amount of time—five or ten minutes—by any school official or employee such as a regular teacher, teacher's aide, guidance counselor, social worker, school psychologist, ESE specialist, principal, administrator as well as parents. The tracking system 10 of the present invention allows the end user to identify the problematic aspects of each student's behavior so that those aspects can be immediately pinpointed and rectified, with the documentation provided by the tracking system 10 continuing throughout the entire student careers.

The computerized accountability system 10 can be used in both regular and alternative schools, and it is advisable that regular schools have at least one classroom of drop out prevention designated for use by this tracking system 10. In a regular school having at least one classroom designated for use by this tracking system 10, it is recommended that students either remain in that classroom all day or the students be mainstreamed out to normal classes with one class used as the homeroom for behavior tracking and documentation purposes. In a normal school students may be given one marking period to successfully complete the program, and if they cannot do so they can be placed in an alternative school setting until their problems are rectified. Although a normal school may not want to use all the criteria the accountability tracking system 10 offers, for documentation and teacher protection purposes it is advisable that all criteria be used.

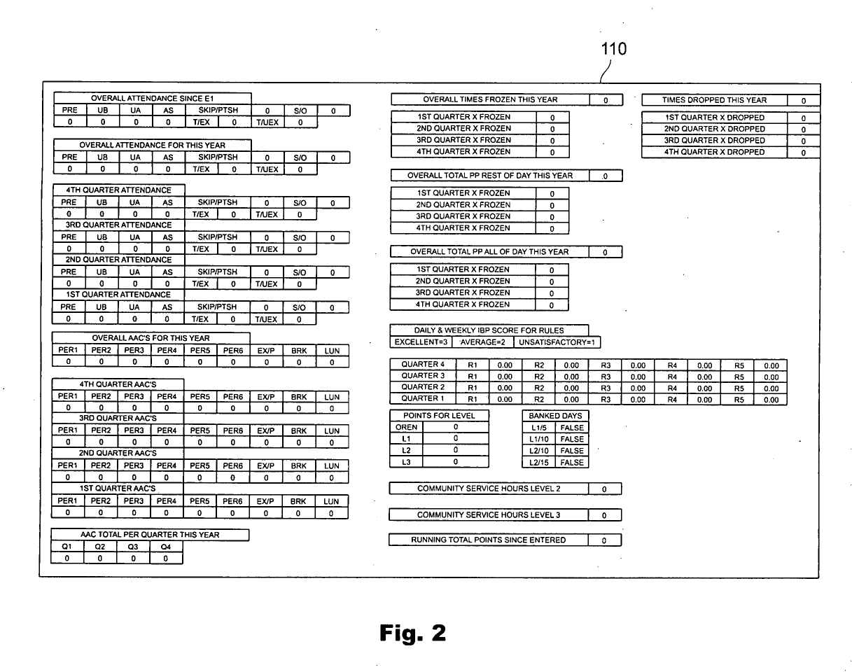

As illustrated in FIGS. 1-5, the computerized accountability tracking system 10 includes numerous categories, criteria and data fields or boxes for specifically tracking the various aspects of the students' behavior on a daily, weekly, monthly or quarterly basis so that points can be accumulated and passage through the levels of the system 10 can occur. With specific reference to FIGS. 1 and 2, an explanation of the meaning and significance of the various system or data fields or boxes will follow. The field labeled PP Rest of Day (permanent placement with security or administration) 12 means that the student stays in the AAC (attitude adjustment class—security or administration) for the rest of the day with the number of days in the AAC being automatically calculated by the tracking system 10. The PP Next Day All Day field 14 designates that the student is to stay in the AAC the following day the entire day with the calculations being done automatically. A Day Before column includes an AAC field 16 that denotes how many times the student was sent to AAC with the calculations done automatically. The C/S/L2 field 18 designates the amount of community service time the student acquires by performing good deeds on level two with the total hours earned being automatically calculated. The C/S/L3 field 20 designates the amount of community service time the student acquires by performing good deeds on level three with the total hours earned being automatically calculated. The levels are color coded with pink associated with the orientation level, white being associated with level one, yellow being associated with level two, and green being associated with level three. Beneath the Orien Box 22 (orientation field heading) is a Pts field 24 that simply means the total points earned over all for each respective student and a Days field 26 that designates the total good days earned over all with all calculations being done automatically by the tracking system 10.

As illustrated in FIG. 1, the Student of the Week pts. field 28 denotes the total points earned for that student for that particular week, and the Student of the Month pts. field 30 denotes the total points earned for that student for that particular month with all calculations being done automatically. The field designated the Unexcused absences/Suspensions/Frozen/Tardy Unexcused/Skip No Point Sheet 32 means the total unexcused absences, suspensions, times frozen, skip no point sheet and tardy unexcused absences for the week while the Excused Absences field 34 denotes the total excused absences, signed out, and tardy excused for that week with all calculations being performed automatically by the system. The Weeks AAC'S field 36 designates how many times for that week the student was sent out of class to AAC (security referral) with all calculations for the above category fields being done automatically.

With reference to the bottom right of screen field or boxes shown in FIG. 1, the D. Frozen box 38 indicates the total days the student is frozen—and frozen means that no privileges can be given (field trips, school store, party's, etc.) with the calculations being done automatically. The D. Un-Froz. Field 40 indicates the total good days to get off being frozen with the calculations being done automatically. The Frozen field 42 designates the total times frozen for the respective student in one quarter and is used for indicating when the respective student should be dropped a level. For this action to occur teacher input is required.

As shown in FIGS. 1 and 2, the Running Total Points field 44 shows the total over all points the student has earned with the calculations being done automatically. The Running Total Points Field 44 can be used for the sole purpose of exiting the program 10. It is for the students that cannot get the required amount of day to move up the levels. 18,000 points is the minimum number of points to get to be considered for exit by the staff. The Banked Days 46 and the L1 48 and L2 fields 50 should be interpreted together in so far as L1 field 48 designates level one and L2 field 50 designates level two with both fields 48 and 50 appropriately color coded; the numbers in each of the fields 48 and 50—5 days, 10 days or 15 days—designate the number of good days the student has completed in a row and calculated automatically.

As shown in FIG. 1 across the top center of the primary screen 52 is a number of fields and associated gray instructor marking boxes that the instructor marks and all of which comprise the attendance row data fields. The PRE field 54 denotes the fact that the student is present and the instructor need only mark the associated box with a number 1. The AB field 56 denotes that the student is absent excused and the instructor need only mark the associated box with a number 1 if this is the case. The UA field 58 denotes that the status of the student is an unexcused absence and the instructor need only mark a number 1 in the associated box if this is the case. The AS field 60 denotes that the status of the student is absent and suspended, and the instructor need only mark a number 1 in the associated box if this is the case. The FROZ field 62 denotes that the student is frozen as aforedescribed, and the instructor does not need to mark the associated box (calculation automatic) if this is in fact the case. The teacher only deletes in this box 62 if the student is unfrozen or dropped a level.

The Skip/No Pt field 64 denotes that the student is present in the school but is skipping class or a point sheet carried by the student was not turned in at the end of the day. The instructor need only mark a number 1 in the associated marking box if this is the case. A wide variety of behavioral objectives can be selected for modification and improvement, and as representative examples are the following: 1.) stay on task; 2.) use appropriate language; 3.) follow directions; 4.) raise hands and wait to be called upon; and 5.) keep hands, feet and other objects to oneself. The Singled out Field 65a denotes that the parent or guardian picked the student up early before school ended. The T/Ex field 65b denotes tardy excused and the T/UEX field 65c denotes tardy unexcused.

The column in the middle left of the primary screen chart 52 illustrated in FIG. 1 that starts with the Rules field box 66 and then proceeding down the column are behavior tracking boxes 68 labeled 1 through 5 that correspond to the above-identified categories or aspects of behavior to be modified or improved upon. To the right of the Rules field box 66 are classroom period fields 70 designated periods 1 through 6 and a field labeled EX/P 72 that means extended period at the end of the day while waiting for bus dismissal. A Breakfast field 74 and a Lunch field 76 are to the right of the period fields 70 and are marked by the teacher according to the points earned by the respective student. The gray-colored boxes are the work area boxes 78 for the instructor, and they are the boxes wherein the instructor places or marks the numbers 1-3 in accordance with the student's attainment or lack of attainment of that particular behavior objective. Please note that all boxes 78 are already filled in if the student has a perfect day. The points can be deleted or changed as necessary by the instructor when the student turns in his or her point sheet at the end of the day. Beneath the columns for the Rules field 66 and Period fields 70 is the ACC field 80 and associated behavior marking gray boxes 82 and the COM/S/L2 field 84 and COM/S/L3 field 86 and associated point marking gray boxes 88 so that community service time and security referrals can be tracked for each period and added, changed, or deleted in accordance with the behavior of each student. The EX/P field 89 denotes the extra points field wherein students are rewarded more points for parent involvement and the extra points can only be added to running total points.

The field labeled the Daily Weekly IBP (individual behavior plan) IBP/Rules field 90, along with the adjacent matrix of IBP score boxes 92, provides the total score for each individual rule that corresponds to the above rules labeled 1-5 located under the Rules field box 66. A score of three indicates excellent, a score of two indicates average, and a score of one indicates unsatisfactory. The calculations for these scores are done automatically per day, per week and per quarter. The large gray-colored box 94 with the Comments field 96 wherein the instructors can write notes to themselves for making certain that they keep track of all the relevant student behaviors. As shown in FIG. 1 in the upper right-hand side of the screen 52 is the Today field 98 that lists the totals for that day after instructor input for the following categories: pts.—points for that day; AAC—security referrals for that day; C/S/L2—community service for that day at level 2; and C/S/L3—community service for that day at level three. Beneath the Totals Daily Field 98 are Points and Days boxes 100 for each level (including orientation) and the Points and Days boxes 100 will give the total points per day calculated automatically. To the right of the Today box 98 is the Overall field 102 beneath which are the ACC 104, the C/S/L2 106 and C/S/L3 fields 108 and associated data point boxes for displaying the final totals after instructor input for that day for the categories of behavior with all calculations being done automatically.

The screen layout or chart 110 illustrated in FIG. 2 is representative of a summary chart for students wherein cumulative points for all the various categories and areas of behavior from security referrals and daily attendance to times froze and unfrozen and community service are tallied and summarized on a quarterly basis, i.e., a first quarter, a second quarter, a third quarter and a fourth quarter basis. This cumulative summary sheet 110 provides instructors with an immediate overview of the gains—and lack of progress—for each student per quarter.

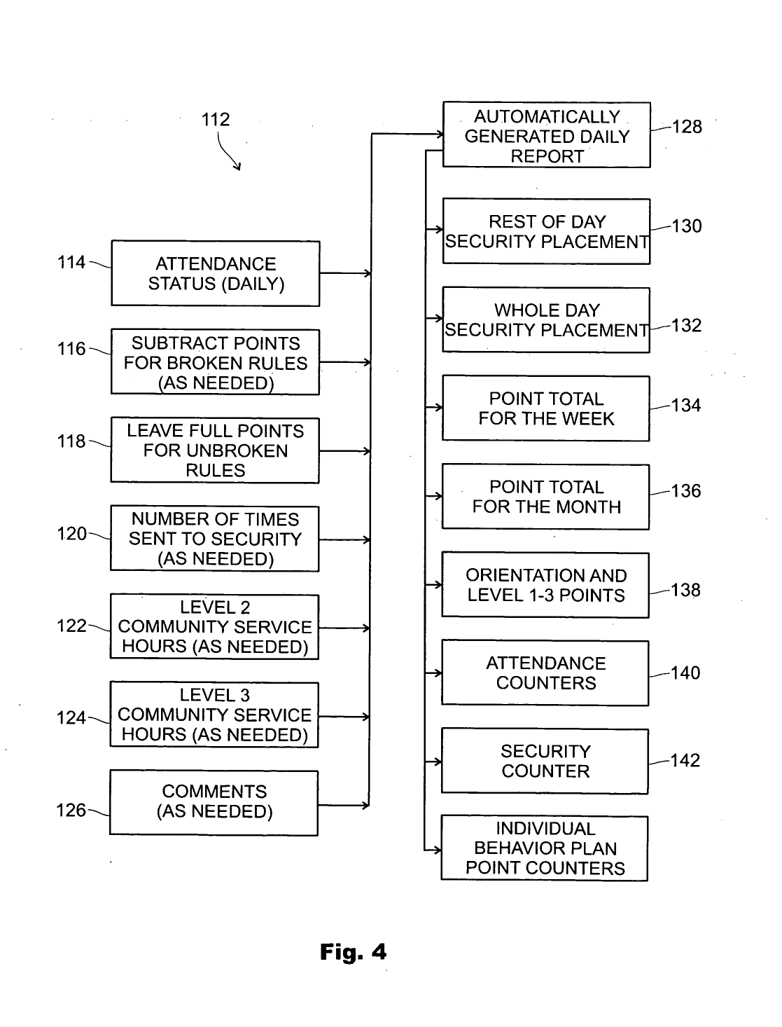

The schematic flowchart 112 of FIG. 4 illustrates the various categories and criteria of behavior that are tracked and tabulated for generating the daily reports as demonstrated by the tracking screen 52 shown in FIG. 1 and for cumulatively adding or deleting points for each student on an ongoing basis. The daily attendance status 114, points subtracted for broken rules 116, points attained for unbroken rules 118, times sent to security (AAC) 120, level 2 community service 122, level 3 community service 124, and the comments 126 as needed are the categories that comprise the automatically generated daily report 128. The categories or criteria whose point totals are tallied to arrive at an individual behavior plan includes security placement for the rest of the day 130, whole day security placement 132, weekly point total 134, monthly point total 136, points accumulated for orientation and levels 1 through 3 138, attendance counters 140, and security counters 142. All of these categories and criteria are totaled as part of the determination of the progress of that student with regard to the various behaviors that are to be modified and improved.

With reference to FIGS. 1 through 5, an overview of the accountability system 10 will be set first forth. It should be first realized that when the teacher opens to a day for a specific student all inputs on the primary student tracking chart 52 are in the gray data field boxes 78; no other boxes or data fields require input and the values for those boxes and fields are automatically calculated. The teacher then places the number 1 in the top attendance row that includes attendance row data fields for present, absent, unexcused absence, tardy excused, tardy unexcused, frozen, absent suspended (which can only be deleted), etc. 54-62, with only one attendance row data field being marked Note: Teacher can only choose one category). Depending on what that particular student has done behaviorally for that day, the teacher deletes and/or places the correct score for that particular behavior; if the student has a perfect day this area or data field can be left alone; points are already there for a perfect day. Below the gray data field boxes 78 are the row of boxes designated the AAC (attitude adjustment class security) field 80 and these boxes can be marked up to three times only when a student was sent out on referral to security.

The fields below the AAC field 80 are the community field service boxes 84 and 86 further subdivided into levels two and three. The instructor marks the appropriate box 84 or 86 for the appropriate level per time period that the student does community service with the time period divided into the following increments: 15 minutes equals 0.25; 30 minutes equals 0.50; 45 minutes equals 0.75; and 1 hour equals 1.0. Below the community field service boxes 84 and 86 is a frozen data field 144. The instructor places a 1 one time in this field 144 and then calculations are done for being frozen, and students are prevented from moving through the various levels until the criteria for being unfrozen are completed. Once the criteria for being unfrozen are met the instructor goes to the top of the chart of FIG. 1 and deletes froze number from the appropriate box or data field 62 of the attendance row. Regular calculations then resume for levels two and three. However, there is a drop data field or box 146, and if the student doesn't complete the criteria for being unfrozen with respect to levels two and three, the drop data box 146 is marked by the instructor with a 1 and the adjacent level field box 148 is marked with level the student is dropped to. It should be noted that in the accountability tracking system 10 of the present invention the primary numbers being used by the instructor, for use or deletion in the various data fields or boxes, are the numbers 1, 2 and 3. The instructor simply reads and reviews the information presented to him or her on the various screen charts for that day, and then scrolls to the next day.

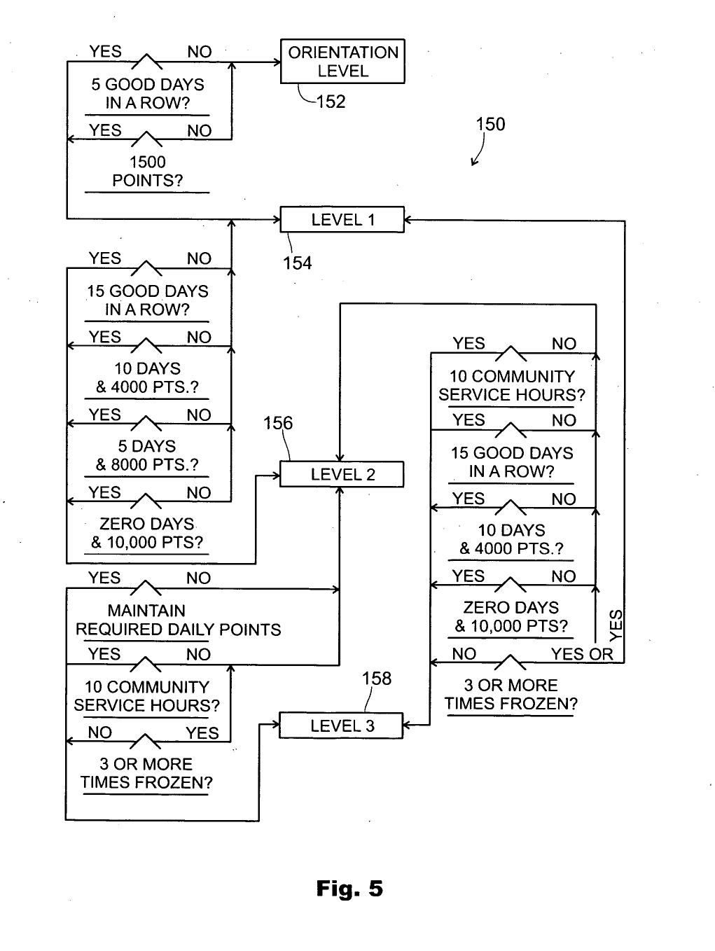

With reference to the schematic flowchart 150 shown in FIG. 5, an overview of the movement through the various levels of the accountability tracking system 10 by the student will now be described. With regard to the orientation level 152, a student can either earn 1500 points or five good days in a row to exit this level. There are no rewards with the orientation level 152. With respect to level 1 154 a student can do 15 days in a row or earn 10,000 points; or a combination of the two such as earning 4,000 points and 10 banked days or 8,000 points and five banked days. Level two 156 includes the same criteria as level one 154 but the student must earn ten community service hours and may have 15 banked days in case the student becomes frozen due to. undesirable behavior. The schematic flowchart that is shown in FIG. 5 is a representation of the actions and points that must be successfully attained and accumulated for the student to progress from the orientation level 152 to level 1 154 and then to level 2 154 and finally to level 3 158. With regard to level three 158 the student must simply maintain his or her level three status and earn ten community service hours. Good days do not actually count on level three 158 except to gain access to more rewards than are available at level one 154 and level two 156. The following are the points per day that are needed to maintain the student at that particular level, and to determine if the student should be allowed to move to the next level for progressing through the system: orientation—101 points; level one—101 points; level two—108 points; and level three—114 points.

While there has been described and illustrated a preferred embodiment for the present invention, numerous modifications, alterations and variations may be made without departing from the spirit of the invention or the scope of the appended claims.

I claim:

1. A computerized accountability tracking system for tracking various categories of student behaviors and assigning points to the behaviors so the student can proceed through the tracking system, comprising:
a primary tracking screen having the following fields for tracking and marking each student's behavior:
an attendance field including the student attendance categories of present, absent, unexcused absence, suspended, skip no point sheet, tardy excused and tardy unexcused;
a rules field for tracking and recording the attainment or non-attainment of predetermined for each classroom period with the rules including staying on task, using appropriate language, following directions, raising one's hands and waiting to be called upon and keeping hands, feet, and other objects to oneself;
an orientation level wherein the student can amass a given number of points and good days to proceed through the orientation level;
a first level wherein the student enters from the orientation level so that the student can amass a given number of points and good days to proceed through the first level;
a second level wherein the student enters from the first level so that the student can amass a given number of points and good days to exit the second level;
a third level wherein the student enters from the second level so that the student can amass a given number of points and good days to exit this level for successfully passing through the tracking system;
an AAC field for tracking the number of times per day and per week the student was sent out on a referral to security;
a community service level two for tracking the community service points earned per hour by the student;
a community service level three for tracking the community service points earned per hour by the student;
a comments field wherein the teacher can enter comments on an ongoing basis regarding the status of the various student behaviors being tracked; and
a totals overall field for calculating the final point totals in all the behavior categories and levels after the teacher input.

2. The computerized accountability tracking system of claim 1 wherein the primary tracking screen further includes a daily IBP rules field for providing the total score accumulated for each rule on a daily, weekly, and quarterly basis.

3. The computerized accountability tracking system of claim 2 wherein the primary tracking screen further includes an orientation level, level 1, level 2, and level 3 are color-coded with specific colors to distinguish these levels from each other.

4. The computerized accountability tracking system of claim 3 wherein the specific colors are pink, white, yellow and green.

5. The computerized accountability tracking system of claim 4 wherein the primary tracking screen further includes a PP Rest of Day field that indicates that the student must stay in the AAC (security referral) for the rest of the day.

6. The computerized accountability tracking system of claim 5 wherein the primary tracking screen further includes a PP Next Day All Day field that indicates that the student stay in the AAC (security referral) all day of the following day.

7. The computerized accountability tracking system of claim 6 wherein the primary tracking screen further includes a Student of the Week field that indicates the total points earned by the student for that week.

8. The computerized accountability tracking system of claim 7 wherein the primary tracking screen further includes a Student of the Month field that indicates the total points earned by the student for that month.

9. The computerized accountability tracking system of claim 8 wherein the points needed by each student to proceed through each level are 101 points for the orientation level, 101 points for level 1, 108 points for level 2, and 114 points for level 3.

10. The computerized accountability tracking system of claim 9 further comprising a summary chart wherein the point totals earned by each student in the various behavior categories are calculated and provided to the teacher on a quarterly basis that includes a first quarter, a second quarter, a third quarter, and a fourth quarter.

11. The computerized accountability tracking system of claim 10 further comprising a general daily report that is provided to the teacher and includes the behavior categories of daily attendance status, points subtracted for broken rules, points maintained for unbroken rules, number of times sent to security, community service hours at level 2, community service hours at level 3, and comments.

12. The computerized accountability tracking system of claim 11 wherein the passage from the orientation level to level 1 and then from level 1 to level 2, and then from level 2 to level 3, is dependent upon the student earning a predetermined number of points or successive good days with the number of points and the successive good days distinctive for each level.
